(19) United States
(12) Patent Application Publication
(10) Pub. No.: US 2011/0108522 A1
(43) Pub. Date: May 12, 2011

(54) MICROSTRUCTURED SEPARATION ELEMENT WITH A POROUS SURFACE COATING

(75) Inventor: Gerard Rozing, Karlsruhe (DE)

(73) Assignee: AGILENT TECHNOLOGIES, INC., Loveland, CO (US)

(21) Appl. No.: 12/989,076

(22) PCT Filed: Apr. 23, 2008
(86) PCT No.: PCT/EP2008/054921

§ 371 Date: Jan. 11, 2011

(51) Int. Cl. C03C 25/68; G01N 27/26; G01N 1/10; G01N 30/02; H01J 49/00; B05D 5/00; B28B 11/08; B29C 35/08

(52) U.S. Cl. 216/54; 204/601; 73/863.21; 73/61.55; 73/23.41; 250/288; 427/245; 264/293; 264/400

(57) ABSTRACT

A fluidic device for separating different components of a sample, the fluidic device comprising a microstructured body and porous material covering at least a portion of a surface of the microstructured body.

### BACKGROUND ART

The present invention relates to the separation of constituents of samples.

In chromatography, a fluid is pumped (or in liquid chromatography, a solvent is pumped) through a column comprising material which is capable of temporally separating the different constituents (analytes) of a sample dissolved in the same or another fluid (or solvent). Such a material, so-called beads which may comprise of silica gel, may be filled into a column tube which may be connected to other elements (like a control unit, containers including sample and/or buffers) using fitting elements.

During operation, a sample traverses the column tube filled with the analyte separating material. Due to the physical interaction between the separating material and the different components in the sample, a temporal separation of these different components may be achieved. Consequently, the separating material filled in the column tube is subject of a permanent mechanical force generated by the fluid pumped from an upstream connection to a downstream connection with a relatively high pressure. Hence, a high-pressure force exerted on the powdery separation material during sample separation may cause the powdery separation material to be flushed out of a separation column.

WO 2006/000469 A1 by the same applicant Agilent Technologies discloses a microfluidic device comprising at least one inlet port, at least one flow path coupled to the inlet port, and at least one fluid separation element coupled to the flow path, wherein the fluid separation element comprises a packing material and is adapted for separating different components of a fluid, wherein the microfluidic device comprises at least one retaining device for keeping the packing material of the fluid separation element fixed in place and protecting the microfluidic device from debris polluting the analyte.

However, the introduction of powdery separation material into a fluid separation element may be a challenge.

Bing He, Niall Tait, and Fred Regnier, Analytical Chemistry, 70 (18), pp. 3790 to 3797, 1998, “Fabrication of Nanocolumns for Liquid Chromatography” discloses that in situ micromachining can be used to simultaneously position and define (i) support particles, (ii) convective transport channels, (iii) an inlet distribution network of channels, and (iv) outlet channels in multiple chromatography columns on a single quartz wafer to the level of a few tenths of a micrometer. Stationary phases are bonded to 5 μm×5 μm×10 μm collocated monolith support structures separated by rectangular channels 1.5 μm wide and 10 μm deep with a low degree of deviation of channel width between the top and bottom of channels. Micro fabrication of sufficiently deep and narrow channels can only be achieved with deep reactive ion etching. The volume of a 150 μm×4.5 cm column is 18 nL. Column efficiency is evaluated in the capillary electrochromatography (CEC) mode using rhodamine 123 and a hydrocarbon stationary phase. Plate heights in these columns are typically 0.6 μm in the nonretained and 1.3 μm in the retained modes of operation. Columns are designed to have identical mobile-phase velocity in all channels in an effort to minimize zone broadening during operation. When the total lateral cross-sectional area of channels at all points along the separation axis is identical, linear velocity of the mobile phase in a CEC column should be the same. Columns are operated at atmospheric pressure.

Kirkland, J J, Langlois, T J, DeStefano, J J, “Fused Core Particles for HPLC Columns”, American Laboratory 39(8), pp. 18 to 21, 2007 discloses the manufacture of fused core particles for High-Performance Liquid Chromatography. Such fused core particles comprise a non-porous core coated with a porous shell.

### DISCLOSURE

It is an object of the invention to provide an efficient sample separation capacity. The object is solved by the independent claims. Further embodiments are shown by the dependent claims.

According to an exemplary embodiment of the present invention, a fluidic device (such as a separation member for a measurement device or a complete measurement device) for separating different components of a (for instance fluidic) sample is provided, the fluidic device comprising a microstructured body (for instance a solid substrate in which micro-dimensioned channels are formed traversing the entire or a part of the solid substrate) and porous material (for instance permeable for a fluidic sample) covering at least a portion of a (for instance internal) surface of the microstructured body.

According to another exemplary embodiment, a method of manufacturing a fluidic device for separating different components of a sample is provided, the method comprising microstructuring a body and covering at least a portion of a surface of the microstructured body with porous material.

According to an exemplary embodiment, a sample separation member may be provided formed on the basis of a solid body which has been treated by a microstructuring procedure, thereby forming hollow structures such as cavities within the body having dimensions or features in the order of magnitude of, for instance, micrometers. On the basis of such a porous or three-dimensionally patterned body, a sample separation member may be formed by covering surface portions, for instance internal surface portions formed by the microstructures, of the microstructured body with a porous material having the capability of physically and/or chemically interacting with different components of a sample, thereby allowing for a separation of different fractions of the sample due to a different affinity of the different fractions to the interior of the porous material.

By taking such measures, an alternative to the conventional provision of powdery beads may be provided for instance for a chromatographic system, eliminating shortcomings of such a bead configuration, and particularly improving the performance and the robustness of such a fluidic device in the presence of a high pressure, for instance of 1200 bar and more.

According to an exemplary embodiment, an integrally formed solid single-piece fluidic device may be obtained which makes complex packing material filling procedures of a capillary dispensable, since such a solid separation member can be used as it is or inserted in a container such as a column as a single piece. A further advantage of such a structure is that the insertion of frits in a chromatographic column may be dispensable, since the problem tackled by frits, namely that powdery separation material can be flushed out of a column in the presence of high pressure, does inherently not occur according to exemplary embodiments in which a single piece microstructured and surface covered separation member is provided.

Next, further exemplary embodiments of the fluidic device will be explained. However, these embodiments also apply to the method.

The microstructured body may comprise pillars between which fluidic paths are defined. Such pillars or posts may be for example column-like components guaranteeing a high mechanical stability and being arrangeable in a regular pattern to provide regular or homogeneous fluid flow velocity properties. Furthermore, a flow can be formed around the arrangement of pillars simultaneously ensuring a proper interaction between the fluidic sample to be separated and the surface functionalization of the pillars in the form of the porous material. It may be advantageous to provide for a constant velocity between the pillars.

The pillars may be arranged parallel to one another. Such a structure may be manufactured with reasonable effort using conventional processing technologies from semiconductor technology and can be formed by deposition, lithography and etching procedures. This arrangement also provides for homogeneous fluid separation properties by providing an ordered structure which simultaneously promotes the laminar flow characteristic.

The pillars may have a diameter in a range between about 1 μm and about 10 μm, particularly in a range between about 2 μm and about 5 μm. Such microscopic posts may also define, in spacings therebetween, channels allowing a fluid to flow when pumped through the arrangement.

Such channels may have a diameter in a range between about 0.1 μm and about 5 μm, particularly in a range between about 0.5 μm and about 1 μm. The channels may extend perpendicular to an extension or alignment of the pillars. In other words an alignment direction of the posts may be normal to a direction along which the fluid is pumped through the fluidic device. Such a fluid flow geometry may be promoted by providing one, two or more lids covering an upper and/or a lower surface of the microstructured body to thereby cover circular cross-sections of the post and channel regions in between, allowing the fluid to flow around the pillars. This geometry may be compared to a walker (as an analogue to the fluidic sample) walking through a forest (as an analogue to the pillars).

The porous material may have a thickness in a range between about 0.1 μm and about 5 μm, particularly in a range between about 0.5 μm and about 1 μm. Thus, a dimension of the porous material may be in the same order of magnitude, particularly may be similar, to a dimension of the channel diameter, thereby providing a proper balance between a sufficiently intensive interaction between porous material and sample on the one hand and an acceptably small flow resistance of the fluidic sample when passing through the channels delimited by the porous material coated pillars.

The microstructured body may comprise a spatially regular pattern of channels. Such a regular pattern may be a hexagonal pattern, a matrix-like pattern, a rectangular pattern, or a triangular pattern. Such a regular pattern provides both mechanical stability and spatially independent fluid propagation properties which contributes to the suppression of undesired dispersion effects.

The porous material may have a uniform thickness over the entire surface of the microstructured body. Thus, over the entire microstructured body, spatially constant fluid separation properties may be provided, thereby preventing undesired dispersion effects. Furthermore, by taking such a measure, a single deposition procedure (for instance from the gas phase or from the liquid phase) may be sufficient for conformally depositing material of a constant thickness onto the posts.

The pillars may be cylindrically shaped. In other words, a cross-section of the pillars may be circular and the extension perpendicular to the circular ground surface may be straight or linear. However, alternatively other pillar geometries are possible such as pillars having a polygonal cross-section (such as a triangular, hexagonal or rectangular cross-section), or the like. An oval cross-section is possible as well.

Different pillars may have the same size. Thus, pillars of an identical dimension may be provided simplifying the manufacturing procedure since a simple mask is sufficient.

The body may be a three-dimensional substrate. For example, the body may be a cuboid substrate or a cylindrical substrate. This body can be made of a single component, for example may consist of only one material. This material may have a homogeneous distribution over the single component body. One example for such a substrate is a silicon wafer or a silicon chip which may be manufactured in accordance with silicon technology, however may not be used as an integrated circuit but as a three-dimensionally microstructured support for a fluid separation coating.

The body may be made of a semiconductor substrate (for instance a group IV semiconductor such as silicon or germanium, or a group III-V semiconductor such as gallium arsenide), may be made of a glass substrate, may be made of a plastic substrate (such as PEEK (polyetheretherketone), or polyimide), a ceramics substrate, or may be made of other materials.

In a preferred embodiment, the body is a microstructured silicon substrate having a silicium dioxide (SiO₂) surface layer (which may serve as a bonding agent and may be formed, for example, by thermal oxidation or deposition), wherein the porous material may comprise silicium dioxide connected to the body via silanol groups (SiOH). In such a configuration, silanol groups in a surface of the silicium dioxide surface layer may allow for a proper chemical bonding with the porous material, therefore providing a very stable configuration. Moreover, such a configuration has the advantage that it can be manufactured easily with silicon technology, since established procedures may be used such as deposition procedures, etching procedures, lithography procedures.

The fluidic device may comprise a lid or cover covering at least one surface of the body which surface has a perpendicular extending in parallel to the pillars. Thus, the pillars being column-like structures may be connected to one another and shielded against an environment via a common plate-like wall or ceiling, as well as by a common bottom plate. By taking this measure, the flowing direction of a fluidic sample to be passed through the fluidic device may be defined, namely to flow parallel to the lids and perpendicular to the alignment of the posts.

The fluidic device may comprise a sample distribution unit adapted for spatially distributing a supplied sample through a plurality of conduits which are in fluid communication with one another and with the microstructured body to thereby distribute the sample over an entire cross-section of the microstructured body. It may happen that the fluidic sample is passed through relatively narrow capillary or conduits before being introduced into the fluidic device. Such an interface between a narrow fluidic conduit and a fluidic device having a larger cross-section may be provided by such a sample distribution unit (see FIG. 7) which may, continuously or in a stepwise manner, widen up a cross-section assumed by the fluidic sample. Such a sample distribution unit may be formed as a part of the microstructured body or may be a separate component to be connected to the microstructured body, for instance by gluing.

For example, the fluidic conduits may be arranged so that, in a sample flow direction, a cross-sectional area of the conduits may be successively decreased and a number of conduits per volume is successively increased. Thus, in a flow direction, the number of for instance parallel-aligned fluidic conduits is increased, whereas a cross-sectional area or a fluidic volume of the conduits is successively decreased in a flowing direction. Thus, some kind of hierarchical structure of conduits may be provided which allows for a distribution of the sample over an enlarged cross-section.

According to one embodiment, only a portion of a solid substrate is microstructured to thereby form an integrally formed container enclosing the microstructured fluid separation portion.

According to another exemplary embodiment, the microstructured body covered with the porous surface material may be inserted into a separate container such as a column as may be used for chromatographic applications. However, such a container does not have to be a hollow cylindrical column, but it is also possible that such a container is formed by a plurality of laminated layers connected to one another, thereby forming an internal bore or recess which can be filled with the microstructured body covered with the porous material.

The microstructuring may be performed by lithography. In other words, a photoresist or the like may be deposited and patterned on a surface of a substrate serving as a mask for the body which may be microstructured by an etching procedure followed by a removal of the mask. However, it is also possible that a laser or even a milling device is used to manufacture the microcavities in the microstructured body. Hot embossing procedures may be implemented as well.

The porous material may be grown on the surface of the microstructured body, for instance may be deposited. However, it is also possible to guide a fluid or even a sol through the microstructured body by treating the system in a manner that the material conducted through the channels between the pillars of the microstructured body adheres to a surface. For this purpose, a sol phase may be particularly appropriate. A sol may be denoted as a colloid that has a continuous liquid phase in which a solid is suspended in a liquid.

The porous layer may be at least permeable for the analytes. In other words, the porous layer may be configured in such a manner that fluid may pass the porous layer. For this purpose, microchannels or pores may be provided in the porous layer having a size which allows the analytes to pass these (micro- or nano-) cavities.

At least part of the porous layer may comprise one or more pores being permeable for the analytes. Such pores or (micro- or nano-) channels may allow to be dimensioned in order to separate components of a sample having particles of a predetermined dimension.

The porous layer may comprise one of the group consisting of glass, polymeric powder, silicium dioxide, and silica gel. However, any separation material can be used which has material properties allowing an analyte passing through this material to be separated into different components, for instance due to a different kind of interaction or affinity between the porous layer and the analyte.

The fluidic device may be adapted as a fritless fluidic device. In other words, the fluidic device may be adapted in such a manner that no frits are provided between fitting elements and two end portions of the column tubes, since the stability functionality of the frits may be fulfilled by the non-powdery solid microstructured body. Therefore, the fluidic device may be manufactured with low costs and may be particularly suitable for small dimensions, since the production of frits becomes more and more difficult when the dimensions of the column tube, particularly the inner surface diameter, decreases and decreases.

The container may comprise a first portion adapted to be coupled to a first fitting element adapted for fitting the container to another element (for instance a liquid chromatography control apparatus and/or containers including sample, solvent, fluid, etc.) within a fluid path, wherein the microstructured body having at least a portion of its surface covered with the porous material is inserted in the first portion. Accordingly, the container may comprise a second portion adapted to be coupled to a second fitting element adapted for fitting the container to another element (such as a fractioner or a waste container) within the fluid path, wherein the microstructured body having at least a portion of its surface covered with the porous material is inserted in the second portion. Thus, particularly one or both end sections of a container may be filled with the solid separation member, allowing to omit frits.

The fluidic device may have an essentially cylindrical shape. However, in contrast to this, any other geometrical configuration of the fluidic device is possible, for instance a tube-like device or a device having a polygonal cross-sectional shape (for instance triangular, rectangular or the like).

The fluidic device may comprise a first essentially planar member and may comprise a second essentially planar member, wherein, when the first essentially planar member is coupled to the second essentially planar member, an accommodation space for receiving the microstructured and coated body may be formed using at least one recess formed in the first essentially planar member and/or in the second essentially planar member. For instance, a configuration which is shaped similar like a “credit card” may be provided.

Such a configuration may be shaped similar as in FIG. 6a, FIG. 6b and corresponding description of US 2004/0156753 A1. FIG. 6a, FIG. 6b and the corresponding description of US 2004/0156753 A1 are explicitly incorporated in the disclosure of this application.

The fluidic device may be adapted to analyze at least one physical, chemical, or biological parameter of at least one compound of the sample. The term “physical parameter” may particularly denote a size of the analyte. The term “chemical parameter” may particularly denote a concentration of a fraction of the analyte, an affinity parameter, or the like. The term “biological parameter” may particularly denote a concentration of a protein, a gene or the like in a biochemical solution, a biological activity of a component, etc.

The fluidic device may be adapted as at least one of a sensor device, a test device for testing a device under test or a substance, a device for chemical, biological and/or pharmaceutical analysis, a capillary electrophoresis device, a liquid chromatography device, a gas chromatography device, an electronic measurement device, and a mass spectroscopy device. Particularly, the fluidic device may be realized as a high performance liquid chromatography device (HPLC) in which different fractions of an analyte may be separated and investigated.

The fluidic device may be adapted as a microfluidic device. The term “microfluidic device” may particularly denote a fluidic device as described herein which allows to convey fluid through micropores, that is pores having a dimension in the order of magnitude of micrometers.

For a manufacturing method, any procedure as known from semiconductor technology may be implemented. Forming layers or components may include deposition techniques like CVD (chemical vapour deposition), PECVD (plasma enhanced chemical vapour deposition), ALD (atomic layer deposition), or sputtering. Removing layers or components may include etching techniques like wet etching, plasma etching, etc., as well as patterning techniques like optical lithography, UV lithography, electron beam lithography, etc.

By manufacturing a separation column on the basis of a microstructured body covered with a surface layer, problems with a reproducible filling in of beads in a container may be overcome. Such a structure may be capable of separating different fractions of a liquid or gaseous sample due to different affinities or interactions between the surface layer and the fluidic sample.

Embodiments may allow to selectively delay different fractions each by a specific delay time and may allow to suppress dispersion. Furthermore, such embodiments may overcome the conventional problems that beads are not manufacturable in a really homogeneous dimension. According to an exemplary embodiment, such problems are met by the idea to use microstructuring techniques for instance as known from semiconductor technology to manufacture regular patterns. Thus, a high density can be combined with a high degree of symmetry.

By first microstructuring a solid body, a high internal surface can be generated. This high internal surface may further be boosted by depositing a thin porous layer on a surface thereof which porous layer contributes to the high active surface by its internal porous surface.

For example, it is possible to use sol particles to grow a layer on a surface of a microstructured platform.

Providing silanol groups at a surface of a silicon oxide covered silicon substrate allows to properly bind the silanol groups with porous silicon oxide deposited on top of such a surface. This may be further improved by promoting a proper bonding by adding heat, for instance by heating during deposition of the porous silicon oxide. Such a heating may include heating to an elevated temperature of, for instance, 200° C. By taking such measures, a proper phase ratio may be combined with a reduction or minimization of dispersion effects.

It may be possible to treat or functionalize a surface of the microstructured body before starting with the deposition procedure of depositing the porous material. Thus, the adherence between the porous surface layer and the microstructured substrate may be further increased.

### BRIEF DESCRIPTION OF DRAWINGS

Other objects and many of the attendant advantages of embodiments will be readily appreciated and become better understood by reference to the following more detailed description of embodiments in connection with the accompanied drawings. Features that are substantially or functionally equal or similar will be referred to by the same reference signs.

FIG. 1 illustrates a liquid chromatography separation system comprising a fluidic device according to an exemplary embodiment.

FIG. 2 shows a three-dimensional view of a liquid chromatography chip including a fluidic device according to an exemplary embodiment.

FIG. 3 to FIG. 5 show different cross-sectional views of layer sequences obtained during manufacturing a fluidic device according to an exemplary embodiment.

FIG. 6 shows a three-dimensional view of a regular pattern of pillars as a basis for a fluidic device according to an exemplary embodiment.

FIG. 7 illustrates a sample distribution unit of a fluidic device according to an exemplary embodiment.

The illustration in the drawing is schematically.

According to an exemplary embodiment, a porous microstructured separation device may be provided.

In high performance liquid chromatography (HPLC), analysis of a liquid sample containing many different substances in a wide range of concentration is achieved through selective time delay of elution when this sample is forced through a porous bed. Traditionally, this porous bed is contained as a porous powder in a cylindrical conduit of sufficient mechanical strength (column) to resist the high pressure incurring by forcing the sample solution through this bed. The bed typically is constructed from particles packed on top of each other. These particles are porous so to provide sufficient internal volume and surface relative to the unoccupied volume in the container (which may be denoted as phase ratio in HPLC) to allow sufficient differential interaction of the sample constituents by which a temporal differentiation of the elution of the substances from the column into a detection device is achieved.

The diameter of these conventional particles may be typically in the order of 3 μm to 10 μm. The resistance to flow through a bed of such particles is governed by the average free space between the particles. For spherical particles with a homogeneous size distribution and orderly packed, this average may be ⅙ of the particle diameter. Recently, a trend to further reduction of this particle size to and/or below 2 μm diameter (sub-two micron, STM particles) is observed. Consequently the pressure required to drive the solvent and sample solution through the column has increased dramatically to 1000 bar and above (for instance to 1200 bar and more) which by itself is utmost demanding on the instrumentation for HPLC. In addition, physical chemical constraints like frictional heat generated by the movement of a solvent under high pressure and change of solvent properties under such extreme pressures are complicating practical usage of HPLC.

A main problem with devices comprising pillars in a flat conduit is to achieve sufficient phase ratio. Exemplary embodiments intend to eliminate or reduce such problems.

According to an exemplary embodiment, a microstructured device may be used as a template (or scaffold) for depositing a porous layer of nanometer sized silica particles and their subsequent chemical modification required for the diverse modes of HPLC. By taking such measures, the main and so far insurmountable problem of the insufficient phase ratio of conventional devices may be solved. At the same time, since the orderly and regular structure of the retaining bed is maintained, HPLC performance will improve dramatically. It needs to be emphasized at this point that in a practical application of HPLC, for instance in the pharmaceutical industry, a concentration dynamic range of 5000 may be required. The separation column should behave linear throughout this range in order to allow accurate and reproducible quantification for instance of a minor impurity in a pharmaceutical formulation. To meet this requirement, sufficient phase ratio is necessary.

In addition, without wishing to be bound to a specific theory, it is presently believed that such a device will also be an excellent separation system for gas chromatomography separations alternative to so-called porous layer columns.

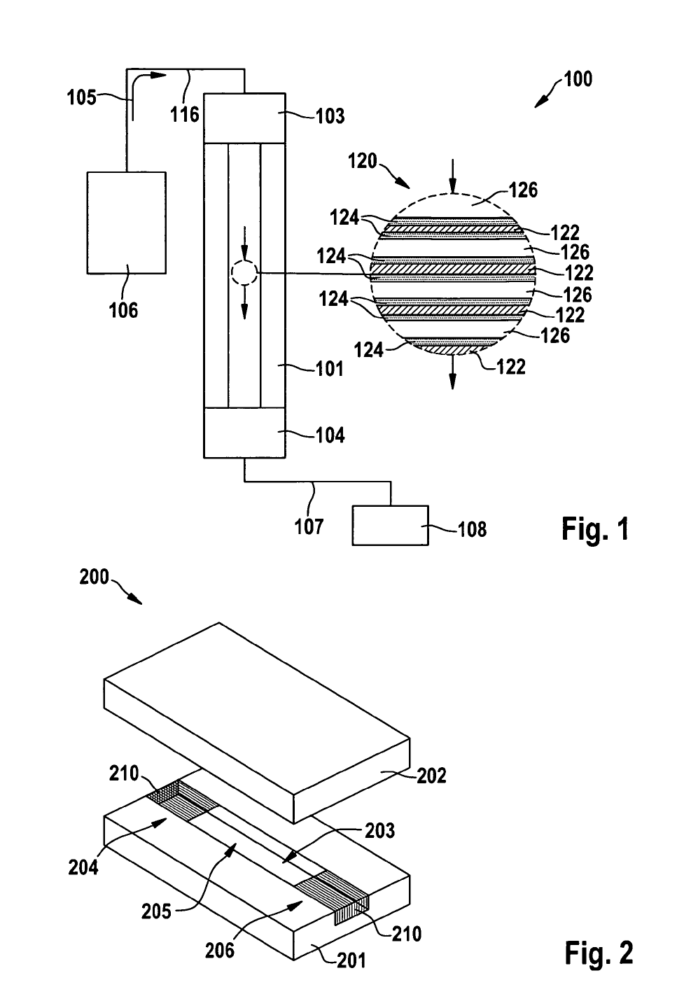

In the following, referring to FIG. 1, a fluidic device 100 according to an exemplary embodiment will be described.

The fluidic device 100 is adapted as a system for carrying out liquid chromatography analysis. The fluidic device 100 for separating different components of a sample which can be pumped through the apparatus 100 comprises a column tube 101 which is shaped as a hollow cylinder. Within the cylinder 101, a tubular reception is defined which is filled with an integrally formed single piece solid separation member 120, as will be explained below in more detail.

The fluidic device 100 is adapted as a fritless fluidic device. In other words, no frits are provided between end portions of the column tube 101 on the one hand and a first fitting element 103 provided upstream the column tube 101 and a second fitting element 104 located downstream of the column tube 101 on the other hand. A flowing direction of fluid which is separated using the fluidic device 100 is denoted with reference numeral 105.

A separation control unit 106 is provided which pumps fluid under a pressure of, for instance, 1200 bar through a connection tube 116 and from there through the fitting element 103 and through the column tube 101. After having left the column tube 101 and the second fitting element 104, a second tube or pipe 107 transports the separated analyte to a container and analysis unit 108. The container and analysis unit 108 includes cavities or containers for receiving the different components of the sample, and may also fulfill computational functions related to the analysis of the separated components.

An enlarged view of the solid fluid separation member 120 shows a microstructured body 122 in the form of parallel aligned pillars, wherein a layer of porous material 124 covers the pillars 122. Between the pillars 122 covered with the porous layer 124, fluidic paths 126 are formed which may also be denoted as channels. The pillars 122 are arranged in parallel to one another and have a diameter of 3 μm. The channels 126 have a diameter of 4 μm. The porous material 124 has a thickness of 0.5 μm. The microstructured body 122 defines a spatially regular pattern of the channels 126. The porous material 124 has a uniform thickness over the entire surface of the microstructured body 122. The pillars 122 are cylindrically shaped. Although not shown in FIG. 1, the pillars 122 are arranged in a matrix-like pattern. The body on the basis of which the microstructured pillars 122 have been manufactured is a three-dimensional substrate. Thus, all pillars 122 are connected to one another to form one single integrally formed body. In the present embodiment, the pillars 122 are made of silicon material and the porous layer 124 is made of a permeable silicon oxide material.

The permeable material 124 is permeable for the fluidic sample pumped through the liquid chromatography apparatus 100, thereby allowing to separate the sample constituents due to a different affinity of different sample constituents with the material of the porous layer 124. An inner diameter of the chromatographic column 101 is 300 μm. The microstructured body 122 covered with the porous material 124 is inserted as a whole and as a single piece into the sample container 101.

In the following, referring to FIG. 2, a microfluidic device 200 according to another exemplary embodiment will be explained.

The microfluidic device 200 comprises a first essentially planar member 201 and a second essentially planar member 202. In an operation state in which the first essentially planar member 201 is coupled to the second essentially planar member 202 (for instance using a gluing connection to form a laminated structure), a column tube is formed in a recess 203 which is formed in the first essentially planar member 201 and using the planar surface of the second essentially planar member 202 as a lid. The recess 203 forms, when the members 201 and 202 are connected to one another, a channel-like structure which has a similar function to the inner bore of the column tube 101 of FIG. 1.

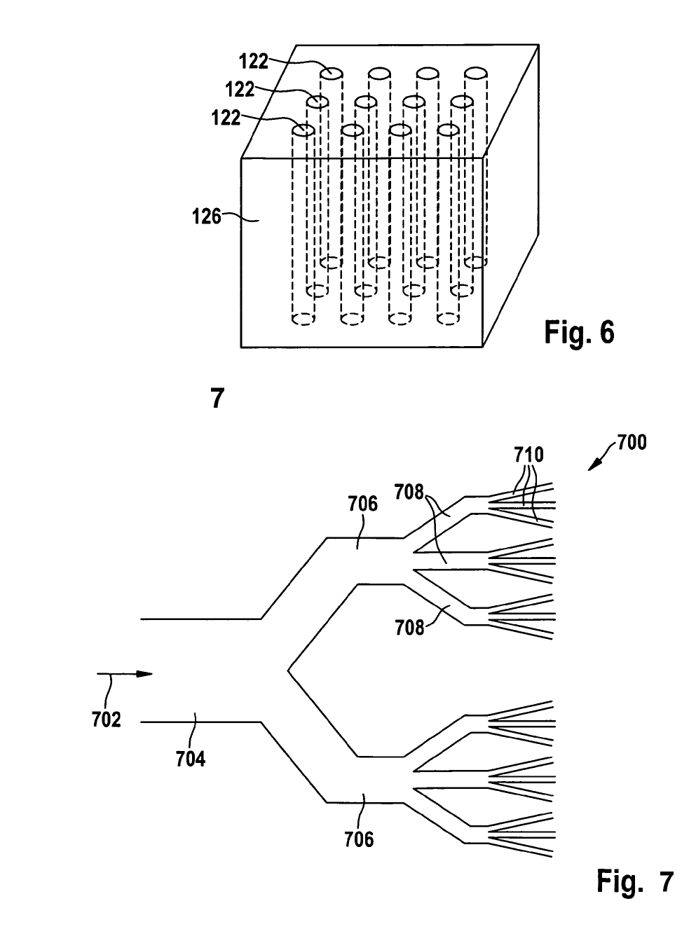

The microfluidic device 200 can be used in a similar manner as described in FIG. 6A, 6B and corresponding description of US 2004/0156753 A1.

FIG. 2 illustrates the patterned polymer substrate 201 having the internal cavity 203 and the other flat substrate 202 that can be bonded with the patterned polymer substrate 201 to form the microfluidic device 200. The flat surface 202 can be formed by any solvent resistant material, including, but not limited to, polymer or glass. The patterned polymer substrate 201 can be formed using any fabrication technique, including embossing, laser ablation, injection molding, etc. It should further be understood that the microfluidic device 200 can include multiple channels 203, and each channel 203 can include a microstructured body 122 having a surface covered with the porous material 124, as explained in FIG. 1, and which can be inserted as a single piece in the channel 203, more precisely in a central portion 205 thereof.

Optional frits 210 are arranged in end portions 204, 206 of the recess 203 to further increase stability, but can alternatively be omitted. As shown in FIG. 2, the channel 203 is divided into three portions, namely a first portion 202 filled with a first frit 210, a second central portion 205 filled with the microstructured body (not shown in FIG. 2), and a third portion 206 filled with the second frit 210.

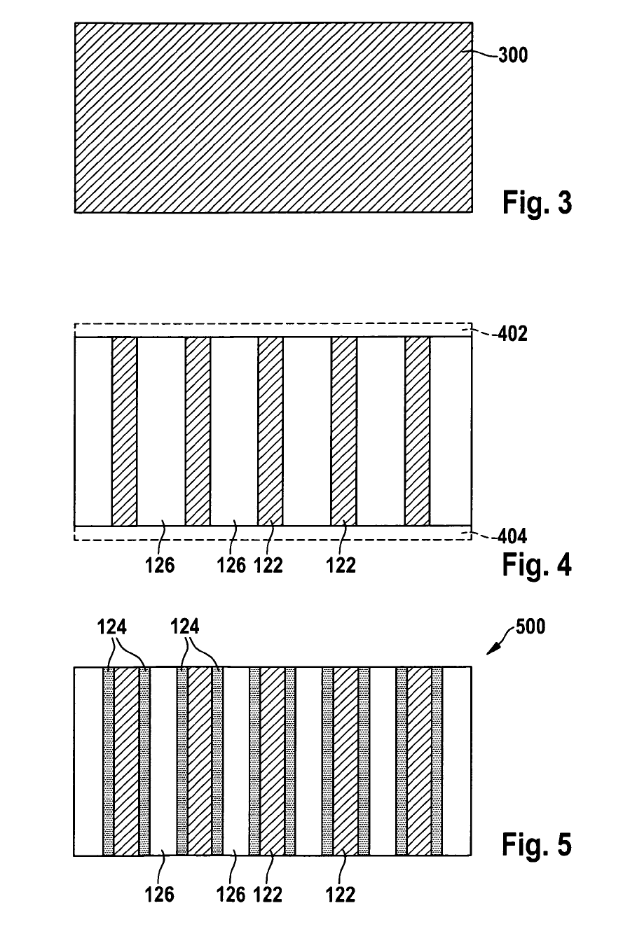

In the following, referring to FIG. 3 to FIG. 5, a method of manufacturing a fluidic device according to an exemplary embodiment will be explained.

FIG. 3 shows a solid continuous silicon substrate 300 such as a silicon wafer used as a starting material.

As shown in FIG. 4, by using deposition, lithography and etching procedures, a regular pattern of silicon pillars 122 is formed on the basis of the silicon substrate 300. Channels 126 are defined as hollow spaces between adjacent pillars 122.

Then, as shown in FIG. 5, a porous material may be deposited on a surface of the pillars 122. For this purpose, a sol material forming the basis of such a porous material may be inserted in or conducted through the channels 126. Optionally, the obtained layer sequence may be covered with an upper lid 402 and a lower lid 404 (see FIG. 4) allowing the sol to react with a surface of the pillars 122. Such a reaction or deposition may be promoted by previously providing a surface functionalization in the surface of the pillars 122. For example, such a functionalization may be an oxidation of a surface layer of the silicon material 122. When the sol is then applied to the channels 126, a deposition of porous material on the surface of the pillars 122 may be triggered by an adjustment of the pH value, by tempering, etc.

Thus, after removing the detachable upper lid 402 and lower lid 404, the fluidic device 500 according to an exemplary embodiment is obtained as a single piece having the pillars 122 covered with the porous material 124 in a regular manner.

As an alternative to the sol deposition procedure, it is also possible to apply a conformal deposition such as CVD, PECVD, or ALD.

FIG. 6 shows a cross-sectional view of the structure shown in FIG. 4, showing the matrix-like arrangement of the pillars 122 separated by the channels 126.

Again referring to FIG. 1, when a sample is supplied from an input channel 116 to the column 101, it may be advantageous to provide an interface for widening up the cross-sectional area which is passed by the fluid.

FIG. 7 shows a sample distribution unit 700 which can be implemented, for instance, at the fittings 103 and/or 104 of FIG. 1, and which allows for spatially distributing a supplied sample 702 through a plurality of conduits of adjacent hierarchical levels, namely a first hierarchical level 704, a second hierarchical level 706, a third hierarchical level 708, a fourth hierarchical level 710, and so on. The number of hierarchical levels may be 2, 3, or more.

As can be taken from FIG. 7, the plurality of conduits 704, 706, 708, 710 are arranged so that, in a sample flow direction 702, a cross-sectional area of the conduits 704, 706, 708, 710 is successively decreased and a number of conduits per volume is successively increased.

It should be noted that the term “comprising” does not exclude other elements or processes and the “a” or “an” does not exclude a plurality. Also elements described in association with different embodiments may be combined. It should also be noted that reference signs in the claims shall not be construed as limiting the scope of the claims.

1. A fluidic device for separating different components of a sample, the fluidic device comprising
a microstructured body; and
porous material covering at least a portion of a surface of the microstructured body wherein the porous material is _{d}rown on the surface of the microstructured body based on a sol phase.

2. The fluidic device of claim 1,
wherein the microstructured body comprises pillars between which fluidic paths forming channels are defined.

3. The fluidic device of claim 2, comprising at least one of:
the pillars are arranged parallel to one another;
the pillars have a diameter in a range between 1 μm and 10 μm, particularly in a range between 2 μm and 5 μm;
wherein the channels have a diameter in a range between 0.1 μm and 5 μm, particularly in a range between 0.5 μm and 1 μm.

4. (canceled)

5. (canceled)

6. The fluidic device of claim 1, comprising at least one of:
the porous material has a thickness in a range between 0.1 μm and 5 μm, particularly in a range between 0.5 μm and 1 μm;
the microstructured body defines a spatially regular pattern of channels;
the porous material has a uniform thickness over the entire surface of the microstructured body.

7. (canceled)

8. (canceled)

9. (canceled)

10. (canceled)

11. (canceled)

12. The fluidic device of claim 1 wherein the microstructured body is or comprises at least one of:
a three-dimensional substrate;
a single-component body;
one of the group consisting of a semiconductor substrate, a glass substrate, a plastic substrate, a ceramics substrate, a silicon substrate, a polyimide substrate, a polyetheretherketone substrate, a polymethacrylate substrate, and a polydimethylsiloxane substrate;
a silicon substrate having a silicon oxide surface layer, and the porous material comprises silicon oxide connected to the microstructured body via silanol groups.

13. (canceled)

14. (canceled)

15. (canceled)

16. (canceled)

17. (canceled)

18. The fluidic device of claim 1,
comprising a sample distribution unit adapted for spatially distributing a supplied sample through a plurality of conduits which are in fluid communication with one another and with the microstructured body to thereby distribute the sample over an entire cross-section of the microstructured body.

19. (canceled)

20. The fluidic device of claim 1, comprising at least one of:
the porous material is at least partially permeable for the sample;
the porous material comprises one or more pores being permeable for the sample and having a size in a range of 1 nm to 100 nm, particularly in a range of 5 nm to 20 nm;
the porous material comprises one of the group consisting of glass, polymeric material, and silica gel;
wherein the porous material has a different affinity regarding an interaction with different components of the sample;
the porous material is adapted for a chromatographic separation of different components of the sample.

21. (canceled)

22. (canceled)

23. (canceled)

24. (canceled)

25. The fluidic device of claim 1,
comprising a container;
wherein the microstructured body having at least a portion of its surface covered with the porous material is inserted, particularly as a whole, in at least a part of the container.

26. The fluidic device of claim 25, wherein the container comprises at least one of:
a column tube;
a first portion adapted to be coupled to a first fitting element adapted for fitting the container to another element within a fluid path, wherein the microstructured body having at least a portion of its surface covered with the porous material is inserted in the first portion;
a second portion adapted to be coupled to a second fitting element adapted for fitting the container to another element within the fluid path, wherein the microstructured body having at least a portion of its surface covered with the porous material is inserted in the second portion;
an inner diameter of less than or equal to 300 μm.

27. (canceled)

28. (canceled)

29. (canceled)

30. (canceled)

31. (canceled)

32. (canceled)

33. (canceled)

34. The fluidic device of claim 1,
wherein the fluidic device comprises a first essentially planar member and comprises a second essentially planar member, wherein, when the first essentially planar member is coupled to the second essentially planar member, the container is formed using at least one recess formed in the first essentially planar member and/or using at least one recess formed in the second essentially planar member.

35. The fluidic device of claim 1, comprising at least one of:
the fluidic device is adapted to analyze at least one physical, chemical, or biological parameter of at least one compound of the sample;
the fluidic device is adapted as at least one of a sensor device, a test device for testing a device under test or a substance, a device for chemical, biological and/or pharmaceutical analysis, a capillary electrophoresis device, a liquid chromatography device, an HPLC device, a gas chromatography device, an electronic measurement device, and a mass spectroscopy device.

36. (canceled)

37. (canceled)

38. A method of manufacturing a fluidic device for separating different components of a sample, the method comprising
microstructuring a body;
covering at least a portion of a surface of the microstructured body with porous material, and
wherein the porous material is grown on the surface of the microstructured body based on a sol phase.

39. The method of claim 38,
comprising inserting the microstructured body having at least a portion of its surface covered with the porous material in a container for manufacturing a fluidic device for separating different components of a sample.

40. The method of claim 38,
wherein the body is microstructured by at least one of the group consisting of lithography, etching, and laser ablation.

41. (canceled)

42. (canceled)

43. The method of claim 38,
wherein the porous material is covered on the surface of the microstructured body by guiding one of the group consisting of a gas and a liquid through the microstructured body.

44. (canceled)

45. (canceled)
